(19) United States
(12) Patent Application Publication
(10) Pub. No.: US 2024/0400760 A1
(43) Pub. Date: Dec. 5, 2024

(54) POLYAMIC ACID AQUEOUS SOLUTION COMPOSITION, AND METHOD FOR PREPARING POLYIMIDE POWDER

(71) Applicant: KOREA RESEARCH INSTITUTE OF CHEMICAL TECHNOLOGY, Daejeon (KR)

(72) Inventors: Jong Chan WON, Daejeon (KR); Yun Ho KIM, Daejeon (KR); No Kyun PARK, Daejeon (KR); Yu Jin SO, Daejeon (KR); Jin Soo KIM, Daejeon (KR); Jong Min PARK, Busan (KR); Sung Mi YOO, Daejeon (KR); Yi Young KANG, Daejeon (KR); Hyun Jin PARK, Daejeon (KR); Yu Mi HA, Daejeon (KR); Ji Yun CHUNG, Daejeon (KR); Hyun Tae LIM, Daejeon (KR); Eun Byeol SEO, Daegu (KR); Ji Won LEE, Daejeon (KR); Hyun Jeong AHN, Daejeon (KR)

(21) Appl. No.: 18/575,707

(22) PCT Filed: May 27, 2022
(86) PCT No.: PCT/KR2022/007606

§ 371 Date: Aug. 16, 2024

(30) Foreign Application Priority Data
Jun. 29, 2021 (KR) 10-2021-0084720
Jun. 29, 2021 (KR) 10-2021-0084721
Jun. 29, 2021 (KR) 10-2021-0084726

(51) Int. Cl. C08G 69/32; C08G 73/10; C08J 3/03

(52) U.S. Cl. CPC C08G 69/32; C08G 73/1021; C08G 73/1028; C08G 73/1071; C08J 3/03; C08J 2377/10

(57) ABSTRACT

The present invention provides a polyamic acid aqueous solution composition capable of polymerizing polyamic acid in water rather than in an organic solvent, as well as achieving a high imidization rate during low-temperature curing.

### CROSS-REFERENCE TO RELATED APPLICATION

This application claims priority to and the benefit of Korean Patent Application No. 10-2021-0084720, filed on Jun. 29, 2021, Korean Patent Application No. 10-2021-0084721, filed on Jun. 29, 2021, and Korean Patent Application No. 10-2021-0084726, filed on Jun. 29, 2021, the disclosures of which are incorporated herein by reference in their entireties.

### TECHNICAL FIELD

The present application relates to a polyamic acid aqueous solution composition, a method of preparing a polyamic acid, a method of preparing a polyimide, and a method of preparing a polyimide powder.

### BACKGROUND ART

With the advent of the 5G mobile communication and Internet of Things (IoT) era, multifunctional, miniaturized, and highly integrated functional materials are required, and accordingly, polyimide polymers have attracted attention as electrical and electronic materials having high heat resistance.

Polyimides are polymer materials having high thermal stability, exhibit excellent mechanical strength, chemical resistance, weather resistance, and heat resistance, and has property stability in a wide range of temperatures (−273° C. to 400° C.). Particularly, since polyimides exhibit electrical insulation, flexibility, and non-flammability, the application thereof in electronic and optical fields have increased.

Typically, polyimides are synthesized by dehydrating a polyamic acid obtained by condensation polymerization of an aromatic dianhydride and an aromatic diamine under an organic solvent. In this synthesis process, synthesis may not be easy due to hydrolysis of an aromatic dianhydride vulnerable to moisture upon condensation polymerization under a solvent. For this reason, the main problems of a polyamic acid synthesized in the organic system include controlling a molecular weight and controlling a crosslinking reaction caused by an initial fast reaction, and the contamination problem resulting from the used organic solvent and the expensive treatment costs to solve the contamination problem still need to be solved

In addition, polyimides need thermal treatment at a high temperature of 250° C. or more for sufficient drying and curing, which causes another problem in that the application of polyimides to products vulnerable to heat is limited.

### DISCLOSURE

### Technical Problem

The present application is directed to providing a polyamic acid aqueous solution composition, which allows not only polymerization of polyamic acid in water rather than an organic solvent but also low-temperature curing, and thus solves the contamination problem resulting from an organic solvent and is able to be applied to a product vulnerable to heat.

The present application is also directed to providing a polyimide film, which achieves a high imidization rate even when a polyamic acid polymerized in water rather than an organic solvent is cured at low temperature.

The present application is also directed to providing a method of preparing a polyimide powder, which is a one-pot process based on aqueous polymerization and is capable of controlling the particle diameter of powder.

### Technical Solution

### A. Polyamic Acid Aqueous Solution Composition

The present application relates to a polyamic acid aqueous solution composition. More specifically, the present application relates to a polyamic acid aqueous solution composition, which allows polymerization in water (aqueous polymerization) and realizes a high imidization rate through low-temperature curing (also referred to as low-temperature imidization). Generally known curing of a polyimide is performed at a temperature exceeding 250° C., whereas low-temperature curing in the present application refers to curing performed at a temperature relatively lower than a general curing temperature, for example, curing performed at 250° C. or less.

An exemplary polyamic acid aqueous solution composition includes: a polyamic acid including a diamine monomer and a dianhydride monomer as polymerization units; and a pyridine derivative compound having at least one electron donating group as an aqueous catalyst. Also, in the present application, an aqueous solution composition refers to a composition including water as a solvent, and other solvents are not allowed.

Another exemplary polyamic acid aqueous solution composition includes: a polyamic acid including a diamine monomer and a dianhydride monomer as polymerization units; and a pyridine derivative compound as an aqueous catalyst, wherein an imidization rate ranges from 70 to 99.9% upon thermal curing at 200° C.

The polyamic acid aqueous solution composition of the present application allows uniform polymerization of polyamic acid in water by including a pyridine derivative compound having at least one electron donating group as an aqueous catalyst as described above. The electron donating group may include an element capable of electron donation, such as oxygen, nitrogen, sulfur, phosphorus, or the like. Examples of the electron donating group include an oxygen anion (—O—), an alcohol (—OH), an ether (—OR), an amine group (—NH₂, —NHR, or —NR₂, wherein R is an alkyl group), and an alkyl group, but the present application is not limited thereto.

In addition, since the aqueous catalyst may react with the carboxyl group of polyamic acid to form a salt, direct polymerization of polyamic acid in water without an organic solvent is possible, and a high imidization rate can be exhibited upon low-temperature curing. For example, in the case of a polyimide film according to the present application, the lower limit of an imidization rate may be 70% or more, 75% or more, 80% or more, 85% or more, 87% or more, 88% or more, 89% or more, or 90% or more, and the upper limit thereof may be 99.9% or less, 99.5% or less, 99.4% or less, 99.3% or less, 99% or less, 98% or less, 97% or less, 96% or less, or 95% or less.

The imidization rate is analyzed by an attenuated total reflectance (ATR) method using a Bruker ALPHA-P infrared spectrometer (IR). The imide bond strength calculated by IR analysis is represented as a percentage, and a ratio of the intensity of C—N stretching of a polyimide film prepared by thermally treating a polyamic acid aqueous solution at 200° C. relative to the intensity of C—N stretching (1375 cm⁻¹) of a polyimide completely imidized at 400° C. is represented as a percentage. Specifically, the imidization rate may be calculated by the following Equation 1.

$$\\ \begin{matrix}Imidization rate ( \% ) = \{ {( 1375 {cm}^{- 1} )}_{200 ° C .} / {( 1510 {cm}^{- 1} )}_{200 ° C .} \} / \{ {( 1375 {cm}^{- 1} )}_{400 ° C .} / {( 1510 {cm}^{- 1} )}_{400 ° C .} \} & [ Equation 1 ]\end{matrix}$$

In an example, the aqueous catalyst may have a boiling point of 50° C. to 500° C. For example, the lower limit of the boiling point may be 55° C. or more, 60° C. or more, 65° C. or more, 70° C. or more, or 75° C. or more, and the upper limit of the boiling point may be 450° C. or less, 400° C. or less, or 350° C. or less. An aqueous catalyst satisfying the above boiling point range exhibits excellent catalytic activity at low temperature.

In an embodiment, the pKa of the aqueous catalyst may vary depending on the type of electron donor, and for example, the aqueous catalyst may have a pKa of 0.01 to 100. For example, the lower limit of the pKa may be 0.05 or more, 0.1 or more, 0.3 or more, 0.5 or more, or 0.7 or more, and the upper limit of the pKa may be 90 or less, 80 or less, 70 or less, 60 or less, 50 or less, 40 or less, 30 or less, 20 or less, or 15 or less.

In an example, the aqueous catalyst may satisfy the following Chemical Formula 1.

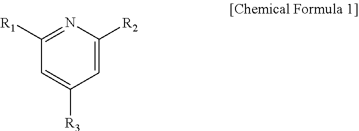

In Chemical Formula 1, at least one of R₁ to R₃ is an alkylamine group, a hydroxyl group, an alkoxy group, a thiol group, a thioether group, an alkyl group, or a heterocyclic group. Although there is no particular limitation on the number of carbon atoms in the substituent, for example, a C1 to C4 alkylamine group, a C1 to C4 alkoxy group, a C1 to C4 thioether group, or a C1 to C4 alkyl group may be used. Also, when one or two of R₁ to R₃ is/are the above-described substituent, the remainder may be hydrogen.

Examples of the aqueous catalyst satisfying Chemical Formula 1 include 4-(methylamino)pyridine, 4-(dimethylamino)pyridine, 2-hydroxypyridine, 4-hydroxypyridine, 4-methoxypyridine, 2-methoxypyridine, 2,6-dimethoxypyridine, 2-ethoxypyridine, 4-mercaptopyridine, 2-mercaptopyridine, 4-(methylthio)pyridine, 2-(methylthio)pyridine, 4-methylpyridine, 2-methylpyridine, 4-ethylpyridine, 2-ethylpyridine, 4-propylpyridine, 2,4,6-trimethylpyridine, 4-piperidinopyridine, 4-morpholinopyridine, and 4-pyrrolidinopyridine.

In another example, the aqueous catalyst may satisfy the following Chemical Formula 2.

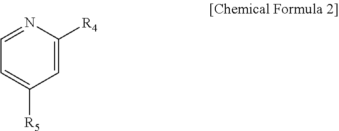

In Chemical Formula 2, at least one of R₄ and R₅ is a C1 to C4 monoalkylamino group, a C1 to C4 dialkylamino group, a hydroxyl group, a C1 to C4 alkoxy group, a thiol group, a C1 to C4 thioether group, a C1 to C4 alkyl group, a piperidino group, a morpholino group, or a pyrrolidino group, and preferably, a C1 to C4 monoalkylamino group, a C1 to C4 dialkylamino group, a piperidino group, a morpholino group, or a pyrrolidino group.

In an embodiment of the present application, examples of the aqueous catalyst satisfying Chemical Formula 2 include 4-dimethylaminopyridine, 2-dimethylaminopyridine, 4-methylaminopyridine, 4-piperidinopyridine, 4-morpholinopyridine, and 4-pyrrolidinopyridine.

The composition of the present application may allow aqueous polymerization and low-temperature curing by including the aqueous catalyst satisfying Chemical Formula 1 and/or 2.

In an embodiment of the present application, the aqueous catalyst may be included in a range of 0.5 to 5 equivalents with respect to 1 equivalent of the carboxyl group in the polyamic acid. In an example, the aqueous catalyst may be included in a range of 0.55 equivalents or more, 0.6 equivalents or more, 0.7 equivalents or more, 0.8 equivalents or more, 0.9 equivalents or more, 1 equivalent or more, 1.5 equivalents or more, or 2 equivalents or more with respect to 1 equivalent of the carboxyl group in the polyamic acid, and the upper limit thereof may be 4.8 equivalents or less, 4.6 equivalents or less, 4.4 equivalents or less, 4 equivalents or less, or 3.5 equivalents or less.

In this specification, an “equivalent with respect to the carboxyl group in polyamic acid,” which defines the amount of aqueous catalyst, may refer to the number of moles of aqueous catalyst used with respect to one carboxyl group in polyamic acid.

In an embodiment, the polyamic acid composition may have a solid content of 1 to 30 wt % or 2 to 20 wt % based on the total weight. In the present application, it is possible to control an increase in viscosity and prevent an increase in manufacturing costs and process time required to remove a large amount of solvent in a curing process by controlling the solid content of the polyamic acid composition.

The polyamic acid aqueous solution composition of the present application is a composition to be subjected to aqueous polymerization and may be substantially free of an organic solvent. In this specification, “substantially free of an organic solvent” may refer to including an organic solvent in an amount of less than 5 wt %, less than 3 wt %, less than 1 wt %, or 0 wt % to 0.5 wt %. The polyamic acid composition that allows aqueous polymerization may be advantageous in terms of a process and environment.

In this specification, the terms “polyamic acid composition,” “polyamic acid solution,” “polyamic acid aqueous solution composition,” and “polyimide precursor composition” may be used with the same meaning. Also, in this specification, the terms “curing” and “imidization” may be used with the same meaning.

The dianhydride monomer that may be used in preparation of the polyamic acid solution may be an aromatic tetracarboxylic dianhydride. For example, the dianhydride monomer includes at least one compound represented by the following Chemical Formula 3.

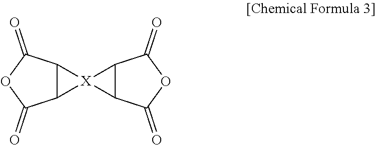

wherein X is a substituted or unsubstituted tetravalent aliphatic ring group, a substituted or unsubstituted tetravalent heteroaliphatic ring group, a substituted or unsubstituted tetravalent aromatic ring group, or a substituted or unsubstituted tetravalent heteroaromatic ring group, and
the aliphatic ring group, the heteroaliphatic ring group, the aromatic ring group, and the heteroaromatic ring group are present alone,
conjugated to each other to form a condensed ring, or
connected by a linking group including one or more divalent substituents selected from the group consisting of a single bond, a substituted or unsubstituted alkylene group, a substituted or unsubstituted alkylidene group, a substituted or unsubstituted alkenylene group, a substituted or unsubstituted alkynylene group, a substituted or unsubstituted arylene group, —O—, —S—, —C(═O)—, —S(═O)₂—, and —Si(Rₐ)₂-(where Rₐ is hydrogen or an alkyl group).

A specific example of the compound of Chemical Formula 3 is a compound represented by the following Chemical Formula 4.

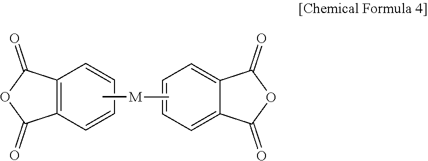

wherein M includes at least one selected from the group consisting of a single bond, an alkylene group, an alkylidene group, —O—, —S—, —C(═O)—, and —S(═O)₂—, and M is substituted with at least one substituent including fluorine and an alkyl group, or unsubstituted. M in Chemical Formula 4 may be an alkylene group or alkylidene group having at least one fluorine-substituted alkyl group as a substituent. In an example, at least one fluorine-substituted C1 to C6 alkyl group may be a perfluoro alkyl group, specifically, a perfluoro methyl group. In another example, the dianhydride monomer component may include at least one dianhydride monomer substituted with at least one fluorine.

In this specification, the term “aliphatic ring group” may refer to a C3 to C30, C4 to C25, C5 to C20, or C6 to C16 aliphatic ring group unless otherwise particularly defined. The tetravalent aliphatic ring group may be, for example, a group in which four hydrogen atoms have been removed from a ring such as a cyclohexane ring, a cycloheptane ring, a cyclodecane ring, a cyclododecane ring, a norbornane ring, an isobornane ring, an adamantane ring, a cyclododecane ring, a dicyclopentane ring, or the like.

In this specification, the term “aromatic ring group” may refer to a C4 to C30, C5 to C25, C6 to C20, or C6 to C16 aromatic ring group unless otherwise particularly defined. The aromatic ring may be a single ring or a condensed ring. The tetravalent aromatic hydrocarbon ring group may be, for example, a group in which four hydrogen atoms have been removed from a benzene ring, a naphthalene ring, an anthracene ring, a phenanthrene ring, a perylene ring, a tetracene ring, or a pyrene ring.

In this specification, the term “arylene group” may refer to a divalent organic group derived from the aromatic ring group.

In this specification, the term “heterocyclic group” includes a heteroaliphatic ring group and a heteroaromatic ring group.

In this specification, the term “heteroaliphatic ring group” may refer to a ring group in which at least one carbon atom of the aliphatic ring group has been replaced with one or more heteroatoms selected from the group consisting of nitrogen, oxygen, sulfur, and phosphorus.

In this specification, the term “heteroaromatic ring group” may refer to a ring group in which at least one carbon atom of the aromatic ring group has been replaced with one or more heteroatoms selected from the group consisting of nitrogen, oxygen, sulfur, and phosphorus unless otherwise particularly defined. The heteroaromatic ring group may be a single ring or a condensed ring.

The aliphatic ring group, the heteroaliphatic ring group, the aromatic ring group, or the heteroaromatic ring group may be each independently substituted with one or more substituents selected from the group consisting of a halogen, a hydroxyl group, a carboxy group, a halogen-substituted or unsubstituted C1 to C4 alkyl group, and a C1 to C4 alkoxy group.

In this specification, the term “single bond” may refer to a bond that connects both atoms without any atom. For example, when M in Chemical Formula 4 is a single bond, both aromatic rings may be directly connected to each other.

In this specification, the term “alkyl group” may refer to a C1 to C30, C1 to C25, C1 to C20, C1 to C16, C1 to C12, C1 to C8, or C1 to C4 alkyl group unless otherwise particularly defined. The alkyl group may have a linear, branched, or cyclic structure and may be optionally substituted with one or more substituents. As the substituent, for example, one or more polar substituents selected from the group consisting of a halogen, a hydroxyl group, an alkoxy group, a thiol group, and a thioether group may be exemplified.

In this specification, the term “alkenyl group” may refer to a C2 to C30, C2 to C25, C2 to C20, C2 to C16, C2 to C12, C2 to C8, or C2 to C4 alkenyl group unless otherwise particularly defined. The alkenyl group may have a linear, branched, or cyclic structure and may be optionally substituted with one or more substituents. As the substituent, for example, one or more polar substituents selected from the group consisting of a halogen, a hydroxyl group, an alkoxy group, a thiol group, and a thioether group may be exemplified.

In this specification, the term “alkynyl group” may refer to a C2 to C30, C2 to C25, C2 to C20, C2 to C16, C2 to C12, C2 to C8, or C2 to C4 alkynyl group unless otherwise particularly defined. The alkynyl group may have a linear, branched, or cyclic structure and may be optionally substituted with one or more substituents. As the substituent, for example, one or more polar substituents selected from the group consisting of a halogen, a hydroxyl group, an alkoxy group, a thiol group, and a thioether group may be exemplified.

In this specification, the term “alkylene group” may refer to a C2 to C30, C2 to C25, C2 to C20, C2 to C16, C2 to C12, C2 to C10, or C2 to C8 alkylene group unless otherwise particularly defined. The alkylene group is a divalent organic group in which two hydrogen atoms have been removed from different carbon atoms, may have a linear, branched, or cyclic structure, and may be optionally substituted with one or more substituents. As the substituent, for example, one or more polar substituents selected from the group consisting of a halogen, a hydroxyl group, an alkoxy group, a thiol group, and a thioether group may be exemplified.

In this specification, the term “alkylidene group” may refer to a C1 to C30, C1 to C25, C1 to C20, C1 to C16, C1 to C12, C1 to C10, or C1 to C8 alkylidene group unless otherwise particularly defined. The alkylidene group is a divalent organic group in which two hydrogen atoms have been removed from one carbon atom, may have a linear, branched, or cyclic structure, and may be optionally substituted with one or more substituents. As the substituent, for example, one or more polar substituents selected from the group consisting of a halogen, a hydroxyl group, an alkoxy group, a thiol group, and a thioether group may be exemplified.

In this specification, the term “alkoxy group” may refer to a C1 to C30, C1 to C25, C1 to C20, C1 to C16, C1 to C12, C1 to C8, or C1 to C4 alkoxy group unless otherwise particularly defined. The alkoxy group may have an alkyl group with a linear, branched, or cyclic structure, and the alkyl group may be optionally substituted with one or more substituents. As the substituent, for example, one or more polar substituents selected from the group consisting of a halogen, a hydroxyl group, an alkoxy group, a thiol group, and a thioether group may be exemplified.

In this specification, the term “alkylamine group” includes monoalkyl amine (—NHR) or dialkyl amine (—NR₂), wherein R may refer to a C1 to C30, C1 to C25, C1 to C20, C1 to C16, C1 to C12, C1 to C8, or C1 to C4 alkyl group unless otherwise particularly defined. Here, the alkyl group may have a linear, branched, or cyclic structure and may be optionally substituted with one or more substituents. As the substituent, for example, one or more polar substituents selected from the group consisting of a halogen, a hydroxyl group, an alkoxy group, a thiol group, and a thioether group may be exemplified.

In this specification, the term “thioether group” or “sulfide” refers to —SR, wherein R may refer to a C1 to C30, C1 to C25, C1 to C20, C1 to C16, C1 to C12, C1 to C8, or C1 to C4 alkyl group unless otherwise particularly defined. Here, the alkyl group may have a linear, branched, or cyclic structure and may be optionally substituted with one or more substituents. As the substituent, for example, one or more substituents selected from the group consisting of a halogen, a hydroxyl group, an alkoxy group, a thiol group, and a thioether group may be exemplified.

Examples of the aromatic tetracarboxylic dianhydride satisfying Chemical Formula 3 include pyromellitic dianhydride (or PMDA), 3,3′,4,4′-biphenyltetracarboxylic dianhydride (or s-BPDA), 2,3,3′,4′-biphenyltetracarboxylic dianhydride (or a-BPDA), oxydiphthalic dianhydride (or ODPA), diphenylsulfone-3,4,3′,4′-tetracarboxylic dianhydride (or DSDA), bis(3,4-dicarboxyphenyl)sulfide dianhydride, 2,2-bis(3,4-dicarboxyphenyl)-1,1,1,3,3,3-hexafluoropropane dianhydride, 2,3,3′,4′-benzophenonetetracarboxylic dianhydride, 3,3′,4,4′-benzophenonetetracarboxylic dianhydride (BTDA), bis(3,4-dicarboxyphenyl)methane dianhydride, 2,2-bis(3,4-dicarboxyphenyl)propane dianhydride, p-phenylenebis(trimellitic monoester acid anhydride), p-biphenylenebis(trimellitic monoester acid anhydride), m-terphenyl-3,4,3′,4′-tetracarboxylic dianhydride, p-terphenyl-3,4,3′,4′-tetracarboxylic dianhydride, 1,3-bis(3,4-dicarboxyphenoxy)benzene dianhydride, 1,4-bis(3,4-dicarboxyphenoxy)benzene dianhydride, 1,4-bis(3,4-dicarboxyphenoxy)biphenyl dianhydride, 2,2-bis[(3,4-dicarboxyphenoxy)phenyl]propane dianhydride (BPADA), 2,3,6,7-naphthalenetetracarboxylic dianhydride, 1,4,5,8-naphthalenetetracarboxylic dianhydride, 4,4′-(2,2-hexafluoroisopropylidene)diphthalic dianhydride (6-FDA), and the like.

The dianhydride monomer may be used alone or in combination of two or more as necessary and may be, for example, PMDA, s-BPDA, or a-BPDA in consideration of bond dissociation energy.

In addition, the diamine monomer that may be used in preparation of the polyamic acid solution is an aromatic diamine, and examples thereof may be classified as follows.
1) a diamine having one benzene nucleus in the structure and a relatively rigid structure, such as 1,4-diaminobenzene (or p-phenylenediamine (PDA)), 1,3-diaminobenzene, 2,4-diaminotoluene, 2,6-diaminotoluene, 3,5-diaminobenzoic acid (or DABA), or the like;
2) a diamine having two benzene nuclei in the structure, such as a diaminodiphenyl ether such as 4,4′-diaminodiphenyl ether (or oxydianiline (ODA)), 3,4′-diaminodiphenyl ether, or the like, 4,4′-diaminodiphenylmethane(methylenediamine), 3,3′-dimethyl-4,4′-diaminobiphenyl, 2,2′-dimethyl-4,4′-diaminobiphenyl, 2,2′-bis(trifluoromethyl)-4,4′-diaminobiphenyl, 3,3′-dimethyl-4,4′-diaminodiphenylmethane, 3,3′-dicarboxy-4,4′-diaminodiphenylmethane, 3,3′,5,5′-tetramethyl-4,4′-diaminodiphenylmethane, bis(4-aminophenyl)sulfide, 4,4′-diaminobenzanilide, 3,3′-dichlorobenzidine, 3,3′-dimethylbenzidine (or o-tolidine), 2,2′-dimethylbenzidine (or m-tolidine), 3,3′-dimethoxybenzidine, 2,2′-dimethoxybenzidine, 3,3′-diaminodiphenyl ether, 3,4′-diaminodiphenyl ether, 4,4′-diaminodiphenyl ether, 3,3′-diaminodiphenylsulfide, 3,4′-diaminodiphenylsulfide, 4,4′-diaminodiphenylsulfide, 3,3′-diaminodiphenylsulfone, 3,4′-diaminodiphenylsulfone, 4,4′-diaminodiphenylsulfone, 3,3′-diaminobenzophenone, 4,4′-diaminobenzophenone, 3,3′-diamino-4,4′-dichlorobenzophenone, 3,3′-diamino-4,4′-dimethoxybenzophenone, 3,3′-diaminodiphenylmethane, 3,4′-diaminodiphenylmethane, 4,4′-diaminodiphenylmethane, 2,2-bis(3-aminophenyl)propane, 2,2-bis(4-aminophenyl)propane, 2,2-bis(3-aminophenyl)-1,1,1,3,3,3-hexafluoropropane, 2,2-bis(4-aminophenyl)-1,1,1,3,3,3-hexafluoropropane, 3,3′-diaminodiphenyl sulfoxide, 3,4′-diaminodiphenyl sulfoxide, 4,4′-diaminodiphenyl sulfoxide, or the like;
3) a diamine having three benzene nuclei in the structure, such as 1,3-bis(3-aminophenyl)benzene, 1,3-bis(4-aminophenyl)benzene, 1,4-bis(3-aminophenyl)benzene, 1,4-bis(4-aminophenyl)benzene, 1,3-bis(4-aminophenoxy)benzene, 1,4-bis(3-aminophenoxy)benzene (or TPE-Q), 1,4-bis(4-aminophenoxy)benzene (or TPE-Q), 1,3-bis(3-aminophenoxy)-4-trifluoromethylbenzene, 3,3′-diamino-4-(4-phenyl)phenoxybenzophenone, 3,3′-diamino-4,4′-di(4-phenylphenoxy)benzophenone, 1,3-bis(3-aminophenylsulfide)benzene, 1,3-bis(4-aminophenylsulfide)benzene, 1,4-bis(4-aminophenylsulfide)benzene, 1,3-bis(3-aminophenylsulfone)benzene, 1,3-bis(4-aminophenylsulfone)benzene, 1,4-bis(4-aminophenylsulfone)benzene, 1,3-bis[2-(4-aminophenyl)isopropyl]benzene, 1,4-bis[2-(3-aminophenyl)isopropyl]benzene, 1,4-bis[2-(4-aminophenyl)isopropyl]benzene, or the like; and
4) a diamine having four benzene nuclei in the structure, such as 3,3′-bis(3-aminophenoxy)biphenyl, 3,3′-bis(4-aminophenoxy)biphenyl, 4,4′-bis(3-aminophenoxy)biphenyl, 4,4′-bis(4-aminophenoxy)biphenyl, bis[3-(3-aminophenoxy)phenyl]ether, bis[3-(4-aminophenoxy)phenyl]ether, bis[4-(3-aminophenoxy)phenyl]ether, bis[4-(4-aminophenoxy)phenyl]ether, bis[3-(3-aminophenoxy)phenyl]ketone, bis[3-(4-aminophenoxy)phenyl]ketone, bis[4-(3-aminophenoxy)phenyl]ketone, bis[4-(4-aminophenoxy)phenyl]ketone, bis[3-(3-aminophenoxy)phenyl]sulfide, bis[3-(4-aminophenoxy)phenyl]sulfide, bis [4-(3-aminophenoxy)phenyl]sulfide, bis[4-(4-aminophenoxy)phenyl]sulfide, bis[3-(3-aminophenoxy)phenyl]sulfone, bis[3-(4-aminophenoxy)phenyl]sulfone, bis[4-(3-aminophenoxy)phenyl]sulfone, bis[4-(4-aminophenoxy)phenyl]sulfone, bis[3-(3-aminophenoxy)phenyl]methane, bis[3-(4-aminophenoxy)phenyl]methane, bis[4-(3-aminophenoxy)phenyl]methane, bis[4-(4-aminophenoxy)phenyl]methane, 2,2-bis[3-(3-aminophenoxy)phenyl]propane, 2,2-bis[3-(4-aminophenoxy)phenyl]propane, 2,2-bis[4-(3-aminophenoxy)phenyl]propane, 2,2-bis[4-(4-aminophenoxy)phenyl]propane(BAPP), 2,2-bis[3-(3-aminophenoxy)phenyl]-1,1,1,3,3,3-hexafluoropropane, 2,2-bis[3-(4-aminophenoxy)phenyl]-1,1,1,3,3,3-hexafluoropropane, 2,2-bis[4-(3-aminophenoxy)phenyl]-1,1,1,3,3,3-hexafluoropropane, 2,2-bis[4-(4-aminophenoxy)phenyl]-1,1,1,3,3,3-hexafluoropropane, or the like.

The diamine monomer may be used alone or in combination of two or more as necessary.

The polyamic acid composition of the present application may be a composition having low viscosity. The polyamic acid composition of the present application may have a viscosity of 20,000 cps or less, 10,000 cps or less, or 6,000 cps or less as measured at a temperature of 25° C. and a shear rate of 30 s⁻¹. Although there is no particular limitation on the lower limit of the viscosity, the lower limit may be 10 cps or more, 15 cps or more, 30 cps or more, 100 cps or more, 300 cps or more, 500 cps or more, or 1000 cps or more. The viscosity may be measured, for example, using VT-550 commercially available from Haake and measured under conditions of a shear rate of 30/s, a temperature of 25° C., and a plate gap of 1 mm. In the present application, a precursor composition having excellent processability can be provided by adjusting the viscosity range.

In an example, the polyamic acid composition may have an inherent viscosity of 0.1 or more or 0.2 or more as measured at a temperature of 30° C. and a concentration of 0.5 g/100 mL (dissolved in water) based on the concentration of the solid thereof. Although there is no particular limitation on the upper limit of the inherent viscosity, the upper limit may be 5 or less, 3 or less, or 2.5 or less. In the present application, by adjusting the inherent viscosity, the molecular weight of a polyamic acid can be appropriately adjusted, and processability can be secured.

In an embodiment, the polyamic acid composition of the present application may have a weight-average molecular weight of 10,000 to 200,000 g/mol, 15,000 to 80,000 g/mol, 18,000 to 70,000 g/mol, 20,000 to 60,000 g/mol, 25,000 to 55,000 g/mol, or 30,000 to 50,000 g/mol after curing. In the present application, the term “weight-average molecular weight” refers to a value converted with respect to standard polystyrene as measured by gel permeation chromatography (GPC).

When the polyamic acid aqueous solution composition of the present application is manufactured into a cured product, the cured product may exhibit excellent properties such as mechanical strength, heat resistance, and the like by satisfying various properties to be described below. In the present application, a cured product of the polyamic acid aqueous solution composition refers to a polyimide.

In an example, a cured product of the polyamic acid aqueous solution composition may have a tensile strength of 50 to 400 MPa measured in accordance with ASTM D882. As the tensile strength is adjusted within the above range, the cured product exhibits excellent mechanical properties.

In addition, a cured product of the polyamic acid aqueous solution composition may have a 5% thermal decomposition temperature (Td) of 400 to 700° C. or 450 to 650° C. measured using a thermogravimetric analyzer (TGA, Q5000 commercially available from TA Instruments, USA). Within the above thermal decomposition temperature range, excellent heat resistance is exhibited without decomposition.

The present application also relates to a method of preparing a polyamic acid. In an example, the method of preparing a polyamic acid aqueous solution composition may include preparing a polyamic acid using a pyridine derivative compound as an aqueous catalyst. Since the preparation method of the present application uses the aqueous catalyst, a polyamic acid which allows aqueous polymerization and low-temperature curing can be prepared. The aqueous catalyst is as described above, and thus a repeated description thereof is omitted.

The present application also relates to a method of preparing a polyimide. The method of preparing a polyimide includes: preparing a polyamic acid using a pyridine derivative compound as an aqueous catalyst; and thermally curing the polyamic acid at 250° C. or less to prepare a polyimide. For example, the thermal curing may be performed at less than 250° C., less than 230° C., or less than 210° C. In the present application, as the above-described aqueous catalyst reacts with the carboxyl group of polyamic acid to form a salt, a polyimide with a high imidization rate can be provided even when low-temperature curing is performed.

The present application also relates to a polyimide. The polyimide may be derived from the above-described polyamic acid aqueous solution composition. The polyimide may be applied to various electrical and electronic materials and may be used, for example, as a binder for an electrode of a lithium battery.

Generally, the positive electrode plate and negative electrode plate in a lithium battery are manufactured by mixing an active material, a conductive material, and a binder by a wet method. In manufacture of the positive and negative electrode plates that generate electrical energy, they need to be in a highly dry state to smoothly generate electrical energy. When the electrode plates contain moisture, oil, and impurities such as gas, a polar action becomes irregular or defective according to the amount of the contained moisture, oil, and impurities, and thus rated energy is not generated. Also, the moisture, oil, and impurities cause poor recharging, and thus the lifespan of a battery is significantly degraded. For this reason, drying the electrode plates is a very important manufacturing process that determines the lifespan of a battery.

However, when a drying temperature is raised for sufficient drying, there is a problem in that the electrode plate is distorted by thermal deformation or the binder is partially dissolved to decrease the adhesion between a current collector and an active material. Also, since a conventional polyimide precursor requires a high imidization temperature exceeding 250° C., deformation of the electrode plate occurs when imidization occurs in the drying process, and copper is highly likely to be oxidized. Also, there is a problem in that the active material, conductive material, and binder peel off from the current collector due to high-temperature drying.

However, since the polyimide of the present application is prepared by low-temperature imidization using the above-described polyamic acid aqueous solution composition, the above problems that may occur at high temperature can be solved.

### B. Polyimide Powder

The present application also provides a method of preparing a polyimide powder, which is a one-pot method based on aqueous polymerization and is capable of controlling the particle diameter of powder.

An exemplary method of preparing a polyimide powder includes: polymerizing a diamine monomer and a dianhydride monomer in an aqueous solution including a pyridine derivative compound as an aqueous catalyst to prepare a polyamic acid; and chemically imidizing the prepared polyamic acid to prepare a polyimide powder.

In the present application, as the pyridine derivative compound, which is an aqueous catalyst, acts as a catalyst for polymerization of polyamic acid and a catalyst for chemical imidization, a polyimide powder can be prepared by a one-pot process. In this specification, an aqueous solution includes water as a solvent and may be substantially free of an organic solvent or include an organic solvent in an amount of less than 5 wt %.

In an embodiment, the chemical imidization may be performed by reacting the polyamic acid and a dehydrating agent. The polyamic acid may be precipitated in the form of a polyimide powder by chemical imidization with a dehydrating agent. As the dehydrating agent, various known materials may be used, and the dehydrating agent may be, for example, an anhydride such as acetic anhydride, propionic anhydride, n-butyric anhydride, or benzoic anhydride.

In an example, the dehydrating agent may be included in a range of 0.5 to 3 equivalents with respect to 1 equivalent of the carboxyl group in the polyamic acid. For example, the dehydrating agent may be included in a range of 0.55 equivalents or more, 0.6 equivalents or more, 0.7 equivalents or more, 0.8 equivalents or more, 0.83 equivalents or more, or 0.93 equivalents or more with respect to 1 equivalent of the carboxyl group in the polyamic acid, and the upper limit thereof may be 2.8 equivalents or less, 2.6 equivalents or less, 2.4 equivalents or less, 2.2 equivalents or less, 2.0 equivalents or less, 1.8 equivalents or less, 1.6 equivalents or less, or 1.4 equivalents or less.

In this specification, an “equivalent with respect to the carboxyl group in polyamic acid,” which defines the amount of dehydrating agent, may refer to the number of moles of dehydrating agent used with respect to one carboxyl group in polyamic acid.

The preparation of a polyimide powder may include: refluxing a chemical imidization product of the polyamic acid at 100 to 150° C. for 1 to 5 hours; and thermally imidizing and drying the refluxed product at less than 500° C., for example, 300 to 490° C. For example, the refluxing may be performed by refluxing a chemical imidization product of the polyamic acid at 100 to 140° C., 100 to 130° C., or 110 to 125° C. for 1 to 4 hours, 1 to 3 hours, or 1.5 to 2.5 hours. The refluxing is intended to prevent the vaporization of the solvent and control the temperature, and an imidization rate may be adjusted by the refluxing. In the present application, a polyimide powder, which is a final product, may be provided by sequentially performing the refluxing, thermal imidization, and drying.

In the present application, controlling the particle diameter of a polyimide powder by adjusting an aqueous catalyst content and/or a polymerization temperature may be included.

For example, this step is capable of controlling the particle diameter of a polyimide powder to be large by adjusting an aqueous catalyst content to be low and controlling the particle diameter of a polyimide powder to be small by adjusting an aqueous catalyst content to be high.

In addition, this step is capable of controlling the particle diameter of a polyimide powder to be small by adjusting a polymerization temperature to be high and controlling the particle diameter of a polyimide powder to be large by adjusting a polymerization temperature to be low.

In the above step, an aqueous catalyst content and a polymerization temperature may be appropriately adjusted within the aqueous catalyst content and polymerization temperature ranges to be described below to obtain a desired particle diameter.

In an example, the aqueous catalyst may be included in a range of 0.5 to 5.0 equivalents with respect to 1 equivalent of the dianhydride in the polyamic acid. For example, the aqueous catalyst may be included in a range of 0.55 equivalents or more, 0.6 equivalents or more, 0.7 equivalents or more, 0.8 equivalents or more, 0.83 equivalents or more, or 0.93 equivalents or more, with respect to 1 equivalent of the dianhydride in the polyamic acid, and the upper limit thereof may be 4.8 equivalents or less, 4.6 equivalents or less, 4.4 equivalents or less, 4.2 equivalents or less, or 4.0 equivalents or less.

In this specification, an “equivalent with respect to the dianhydride in polyamic acid,” which defines the amount of aqueous catalyst, may refer to the number of moles of aqueous catalyst used with respect to one dianhydride in polyamic acid.

As the aqueous catalyst content and the polymerization temperature are appropriately adjusted within the above ranges, a polyimide powder finally obtained in the present application may have an average particle diameter of 10 to 1000 μm. The lower limit of the average particle diameter may be, for example, 100 μm or more, 300 μm or more, or 400 μm or more, and the upper limit thereof may be 900 μm or less, 800 μm or less, or 700 μm.

In an example, as the aqueous catalyst, the compound of Chemical Formula 1 or 2 may be used. Chemical Formula 1 or 2 is as described above, and thus a repeated description thereof is omitted.

The aqueous catalyst satisfying Chemical Formula 1 and/or Chemical Formula 2 may act as a catalyst for polymerization of polyamic acid and an imidization catalyst at the same time, and accordingly, a polyimide powder may be provided by a one-pot process according to the preparation method of the present application.

The dianhydride monomer that may be used in preparation of a polyamic acid may be an aromatic tetracarboxylic dianhydride. For example, the dianhydride monomer includes at least one compound represented by Chemical Formula 3 or 4. Chemical Formula 3 or 4 is as described above, and thus a repeated description thereof is omitted.

In addition, the diamine monomer that may be used in preparation of the polyamic acid solution is an aromatic diamine, and a specific example of an aromatic diamine including 1 to 4 benzene nuclei is as described above.

The present application also relates to a method of manufacturing a polyimide molded article. The method may include processing a polyimide powder prepared by the above-described method to manufacture a polyimide molded article. For example, the processing may be performed by heating and/or pressurizing. Specifically, in the present application, a polyimide powder may be processed by sequentially performing: a first heating step of inputting a polyimide powder into a mold and performing heating at 200 to 600° C., 300 to 500° C., or 350 to 450° C. for 5 to 30 minutes; a pressurizing step of performing pressurization at 1 to 100 MPa, 5 to 50 MPa, or 10 to 20 MPa for 1 to 10 minutes or 1 to 5 minutes; and a second heating step of performing heating at 300 to 1000° C., 350 to 800° C., or 400 to 600° C. for 1 to 10 minutes.

The present application also relates to a polyimide powder prepared by a one-pot process according to the above-described method of preparing a polyimide powder. The polyimide powder may have an average particle diameter of 1 to 1000 μm, 5 to 800 μm, or 10 to 500 μm. Also, the polyimide powder may have a 5% thermal decomposition temperature (Td) of 400 to 700° C. or 450 to 650° C. as measured using a thermogravimetric analyzer (TGA, Q5000 commercially available from TA Instruments, USA).

The present application also relates to a polyimide molded article manufactured by the above-described method of manufacturing a polyimide molded article. The molded article exhibits excellent properties such as mechanical strength, heat resistance, and the like and may specifically satisfy the following properties.

In an example, a 5% thermal decomposition temperature (Td) may be 400 to 700° C., or 450 to 650° C. as measured using a thermogravimetric analyzer (TGA, Q5000 commercially available from TA Instruments, USA).

In addition, a coefficient of thermal expansion (CTE) may be 10 to 100 ppm/° C., 20 to 90 ppm/° C., or 30 to 80 ppm/° C. as measured by thermomechanical analysis (TMA, Q400 commercially available from TA Instruments).

Additionally, a tensile strength may be 1 to 100 MPa, 5 to 80 MPa, or 10 to 60 MPa as measured in accordance with ASTM D1708. The molded article exhibits excellent mechanical properties by adjusting a tensile strength within the above range.

### Advantageous Effects

The present application provides a polyamic acid aqueous solution composition, which allows not only polymerization of polyamic acid in water rather than an organic solvent but also low-temperature curing with a high imidization rate.

A method of preparing a polyimide powder according to the present application solves the contamination problem resulting from an organic solvent by being based on aqueous polymerization, enhances process convenience by performing a one-pot process, and is capable of controlling the particle diameter of powder.

### DESCRIPTION OF DRAWINGS

FIG. 1 is a graph showing the results of an imidization rate experiment according to an example of the present application.

FIG. 2 is a graph showing a relationship between an aqueous catalyst content and a particle size.

FIG. 3 is a graph showing a relationship between a polymerization temperature and a particle size.

### MODES OF THE INVENTION

Hereinafter, the present application will be described in further detail with reference to examples of the present application. However, it should be understood that the following examples are not intended to limit the scope of the present application.

### Example 1A: Polyamic Acid Aqueous Solution Composition

63.7 g of distilled water as a solvent was input into a reactor equipped with a temperature controller and filled with nitrogen. 1.0814 g (0.0094 mol) of p-phenylenediamine (pPDA) and 2.5 equivalents (relative to a carboxyl group) of 4-dimethylaminopyridine were added thereto, and the resulting mixture was dissolved using a mechanical stirrer at 25° C. for 1 hour. Then, 2.9422 g (0.01 mol) of 3,3′,4,4′-biphenyltetracarboxylic dianhydride (s-BPDA) was added, and the resulting mixture was polymerized while stirring at 70° C. for 18 hours to prepare a water-soluble polyamic acid.

Afterward, the obtained polyamic acid was casted onto a glass substrate with a bar coater, defoamed and dried in a vacuum oven at 25° C. for 2 hours, and sequentially thermally imidized at 80° C. for 30 minutes, at 120° C. for 30 minutes, at 180° C. for 30 minutes, and at 200° C. for 30 minutes to prepare a 25 μm-thick polyimide film.

Various polyamic acid aqueous solution compositions and polyimide films according to examples and comparative examples were prepared under the composition conditions shown in Table 1 in the same manner as in Example 9A (the amount of each aqueous catalyst added in the examples and comparative examples was 2.5 equivalents relative to a carboxyl group).

TABLE 1

| | | | | Solid | Solution | |
|---|---|---|---|---|---|---|
| | | | | content | viscosity | Inherent |
| | Dianhydride | Diamine | Aqueous catalyst | (wt %) | (cps) | viscosity |
| Example 1A | BPDA | pPDA | 4-(methylamino)pyridine | 10 | 873 | 0.67 |
| Example 2A | BPDA | pPDA | 4-(dimethylamino)pyridine | 20 | 19303 | 0.90 |
| Example 3A | BPDA | pPDA | 2-(dimethylamino)pyridine | 10 | 8426 | 0.87 |
| Example 4A | BPDA | ODA | 4-(dimethylamino)pyridine | 8 | 1834 | 0.52 |
| Example 5A | BPDA | ODA | 2-(dimethylamino)pyridine | 8 | 1650 | 0.46 |
| Example 6A | OPDA | pPDA | 4-(dimethylamino)pyridine | 2 | 508 | 0.45 |
| Example 7A | BPDA | ODA | 4-hydroxypyridine | 8 | 2767 | 0.70 |
| Example 8A | BPDA | ODA | 2-hydroxypyridine | 8 | 1021 | 0.63 |
| Example 9A | BTDA | pPDA | 4-methoxypyridine | 10 | 1423 | 0.39 |
| Example 10A | BTDA | pPDA | 2-ethoxypyridine | 10 | 1753 | 0.42 |
| Example 11A | BPDA | pPDA | 4-mercaptopyridine | 10 | 2369 | 0.86 |
| Example 12A | BPDA | pPDA | 2-mercaptopyridine | 10 | 2559 | 0.79 |
| Example 13A | 6FDA | pPDA | 4-(methylthio)pyridine | 10 | 567 | 0.36 |
| Example 14A | 6FDA | pPDA | 2-(methylthio)pyridine | 10 | 992 | 0.46 |
| Example 15A | BPDA | m-TB | 4-methylpyridine | 7 | 1810 | 0.36 |
| Example 16A | BPDA | m-TB | 2-ethylpyridine | 4 | 756 | 0.55 |
| Example 17A | BPDA | m-TB | 4-propylpyridine | 7 | 980 | 0.45 |
| Example 18A | BPDA | m-TB | 2,4,6-trimethylpyridine | 7 | 6508 | 0.95 |
| Example 19A | BPDA | ABIZ | 4-piperidinopyridine | 9 | 1352 | 0.77 |
| Example 20A | BPDA | pPDA | 4-morpholinopyridine | 15 | 17567 | 0.87 |
| Example 21A | BPDA | pPDA | 4-pyrrolidinopyridine | 9 | 5142 | 0.74 |
| Comparative | BPDA | pPDA | NMP (organic solvent) | 10 | 20000 | 2.01 |
| Example 1A | | | | | | |
| Comparative | BPDA | pPDA | Pyridine | Polymerization X | | |
| Example 2A | | | | | | |
| Comparative | BPDA | pPDA | 1,2-dimethylimidazole | 10 | 2369 | 0.96 |
| Example 3A | | | | | | |

BPDA: 3,3′,4,4′-biphenyltetracarboxylic dianhydride
BTDA: 3,3′,4,4′-benzophenonetetracarboxylic dianhydride
pPDA: p-Phenylenediamine
ODA: 4,4′-diaminodiphenyl ether
m-TB: 2,2-dimethylbenzidine
ABIZ: 2-(p-aminophenyl)-5-aminobenzimidazole

Comparative Example 1A is an example in which polyamic acid is polymerized under an organic solvent, and Comparative Example 3A exhibited a low imidization rate at 200° C. even though polyamic acid was polymerized under water. Also, Comparative Example 2A showed that polyamic acid was not polymerized under water.

On the other hand, in the case of Examples 2A to 21A, it can be confirmed that polyamic acid was aqueous-polymerized, and a polyimide was prepared with a high imidization rate after the polymerized polyamic acid was thermally cured at 200° C.

### 1A. Measurement of Solution Viscosity

The solution viscosity of each polyamic acid composition prepared in the examples and comparative examples was measured at a shear rate of 30/s, a temperature of 25° C., and a plate gap of 1 mm using VT-550 commercially available from Haake, and results thereof are shown in Table 1.

### 2A. Inherent Viscosity

Each polyamic acid composition prepared in the examples and comparative examples was diluted so that a concentration became 0.5 g/dl (solvent:water) based on a solid concentration. The flow time (Ti) of the resulting solution was measured at 30° C. using a Cannon-Fenske viscometer No. 100. An inherent viscosity was calculated by the following equation using the flow time (To) of blank water, and results thereof are shown in Table 1.

$$\\ Inherent viscosity = \{ ln ( {T}_{1} / {T}_{0} ) \} / 0.5$$

### 3A. Measurement of Imidization Rate

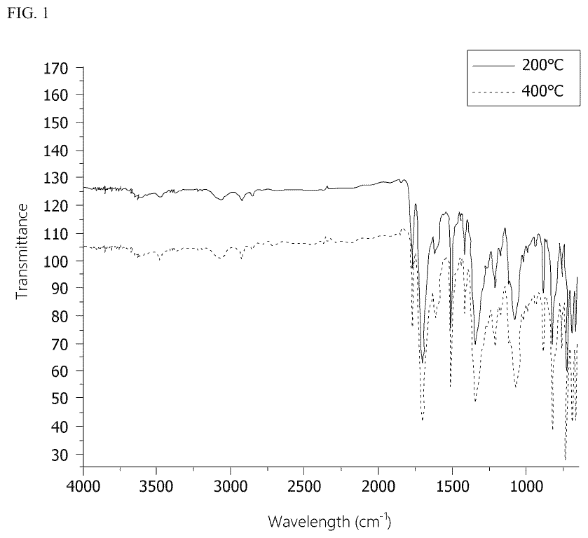

The imidization rates of several examples and comparative examples were analyzed by an attenuated total reflectance (ATR) method using a Bruker ALPHA-P infrared spectrometer (IR). The imide bond strength calculated by IR analysis was represented as a percentage, and a ratio of the intensity of C—N stretching of a polyimide prepared by thermally treating each polyamic acid aqueous solution of the examples and comparative examples at 200° C. relative to the intensity of C—N stretching (1375 cm⁻¹) of a polyimide completely imidized at 400° C. was represented as a percentage. The imidization rate was calculated by the following Equation, and results thereof are shown in FIG. 1 and Table 2.

$$\\ \begin{matrix}Imidization rate ( \% ) = \{ {( 1375 {cm}^{- 1} )}_{200 ° C .} / {( 1510 {cm}^{- 1} )}_{200 ° C .} \} / \{ {( 1375 {cm}^{- 1} )}_{400 ° C .} / {( 1510 {cm}^{- 1} )}_{400 ° C .} \} & [ Equation ]\end{matrix}$$

FIG. 1 is a graph showing an imidization rate result according to Example 1. From FIG. 1, it can be confirmed that the polyamic acid aqueous solution composition according to Example 1 stably exhibited a high imidization rate upon low-temperature curing.

### 4A. Tensile Strength

Each polyimide film of several examples and comparative examples was cut to a width of 10 mm and a length of 40 mm, and modulus and tensile strength were measured in accordance with ASTM D-882 using an Instron 5564 UTM instrument commercially available from Instron. In this case, measurement was made at a cross head speed of 50 mm/min, and results thereof are shown in Table 2 below.

### 5A. 5% Thermal Decomposition Temperature

A thermogravimetric analyzer (Q5000 model commercially available from TA Instruments) was used, each polyimide film (molded article) of several examples and comparative examples was heated to 800° C. at 10° C./min under a nitrogen atmosphere, and a temperature at which a weight loss of 5% occurred was measured. Results thereof are shown in the following Table 2.

TABLE 2

| | | | | 200° C. | | |
|---|---|---|---|---|---|---|
| | | | | imidization | Tensile | Td |
| | Dianhydride | Diamine | Aqueous catalyst | rate (%) | strength | 5% |
| Example 1A | BPDA | pPDA | 4-(methylamino)pyridine | 99.2 | 378 | 604 |
| Example 2A | BPDA | pPDA | 4-(dimethylamino)pyridine | 97.4 | 255 | 591 |
| Example 7A | BPDA | ODA | 4-hydroxypyridine | 91.8 | 299 | 553 |
| Example 9A | BTDA | pPDA | 4-methoxypyridine | 98.4 | 167 | 550 |
| Example 11A | BPDA | pPDA | 4-mercaptopyridine | 95.3 | 234 | 587 |
| Example 13A | 6FDA | pPDA | 4-(methylthio)pyridine | 92.5 | 150 | 516 |
| Example 18A | BPDA | m-TB | 2,4,6-trimethylpyridine | 98.6 | 312 | 576 |
| Example 19A | BPDA | ABIZ | 4-piperidinopyridine | 90.1 | 240 | 559 |
| Comparative | BPDA | pPDA | NMP (organic solvent) | 73.4 | 352 | 616 |
| Example 1A | | | | | | |
| Comparative | BPDA | pPDA | 1,2-dimethylimidazole | 88.6 | 275 | 589 |
| Example 3A | | | | | | |

### Example 1B: Polyimide Powder

446 g of distilled water as a solvent and 21.3798 g (1.25 equivalents relative to a carboxyl group) of 4-dimethylaminopyridine were input into a 1 L round bottom flask equipped with a temperature controller and a reflux condenser and filled with nitrogen, and the resulting mixture was dissolved using a mechanical stirrer at 25° C. Subsequently, 7.5698 g (0.07 mol) of p-phenylenediamine (pPDA) was dissolved, 20.5954 g (0.07 mol) of biphenyltetracarboxylic dianhydride (BPDA) was added, and polymerization was performed while stirring at 25° C. for 18 hours. Then, 16.54 mL (1.25 equivalents relative to a carboxyl group) of acetic anhydride was added, chemical imidization was performed while stirring for 20 minutes to precipitate a polyimide powder, and the precipitated polyimide powder was refluxed at 120° C. for 2 hours to prepare a polyimide powder.

The polyimide powder was washed and subjected to imidization and drying at 400° C. The dried polyimide powder was input into a mold, heated at 300° C. for 10 minutes, then pressurized at 20 MPa for 2 minutes, and heated at 450° C. for 5 minutes to obtain a polyimide molded article.

Various polyimide powders and polyimide molded articles according to examples and a comparative example were prepared under composition and reaction temperature conditions shown in Table 3 in the same manner as in Example 1B.

TABLE 3

| | | | | Reaction |
|---|---|---|---|---|
| | | | | temperature |
| | Dianhydride | Diamine | Aqueous catalyst | (° C.) |
| Example 1B | BPDA | pPDA | 4-dimethylaminopyridine (2.5 equivalents) | 120 |
| Example 2B | BPDA | pPDA | 4-dimethylaminopyridine (2.0 equivalents) | 120 |
| Example 3B | BPDA | pPDA | 4-dimethylaminopyridine (3.0 equivalents) | 120 |
| Example 4B | BPDA | pPDA | 4-dimethylaminopyridine (3.5 equivalents) | 120 |
| Example 5B | BPDA | pPDA | 4-dimethylaminopyridine (4.0 equivalents) | 120 |
| Example 6B | BPDA | pPDA | 4-dimethylaminopyridine (2.5 equivalents) | 80 |
| Example 7B | BPDA | pPDA | 4-dimethylaminopyridine (2.5 equivalents) | 100 |
| Example 8B | BPDA | pPDA | 4-dimethylaminopyridine (2.5 equivalents) | 140 |
| Example 9B | PMDA | pPDA | 4-dimethylaminopyridine (2.5 equivalents) | 120 |
| Example 10B | OPDA | pPDA | 4-dimethylaminopyridine (2.5 equivalents) | 120 |
| Example 11B | BTDA | pPDA | 4-dimethylaminopyridine (2.5 equivalents) | 120 |
| Comparative | BPDA | pPDA | dimethylimidazole (2.5 equivalents) | 120 |
| Example B | | | | |

BPDA: Biphenyltetracarboxylic dianhydride
BTDA: 3,3′,4,4′-benzophenonetetracarboxylic dianhydride
pPDA: p-Phenylenediamine
PMDA: Pyromellitic dianhydride

In addition, the polyamic acid compositions prepared in the examples and comparative examples had a solid content of 10 wt %, and the properties thereof were evaluated by methods described below.

### 1B. Average Particle Diameter

The particle size of each powder prepared in the examples and comparative example, which was in a dispersed state in D.I water, was measured using a particle size analyzer (Microtrac S3000 model), and results thereof are shown in Table 4 below.

### 2B. 5% Thermal Decomposition Temperature

A thermogravimetric analyzer (Q5000 model commercially available from TA Instruments) was used, the polyimide molded article was heated to 800° C. at 10° C./min under a nitrogen atmosphere, and a temperature at which a weight loss of 5% occurred was measured. Results thereof are shown in Table 4 below.

### 3B. Coefficient of Thermal Expansion

Measurement was made by thermomechanical analysis (TMA, Q400 commercially available from TA instruments). In this case, a measurement temperature was 280° C., a heating rate was 10° C./min, and a force applied to pull the molded article was set to 0.05 N. Results thereof are shown in Table 4 below.

### 4B. Tensile Strength

The polyimide molded article was cut into a dog-bone-type piece with a width of 10 mm and a length of 40 mm, and modulus and tensile strength were measured in accordance with ASTM D-1708 using an Instron 5564 UTM instrument commercially available from Instron. In this case, measurement was made at a cross head speed of 5 mm/min, and results thereof are shown in the following Table 4.

TABLE 4

| | Average | 5% thermal | Coefficient | |
|---|---|---|---|---|
| | particle | decomposition | of thermal | Tensile |
| | diameter | temperature | expansion | strength |
| | (μm) | (° C.) | (ppm/° C.) | (MPa) |
| Example 1B | 55.2 | 624 | 53.6 | 35.5 |
| Example 2B | 89.3 | 603 | 51.7 | 32.2 |
| Example 3B | 42.3 | 610 | 57.6 | 37.0 |
| Example 4B | 25.6 | 609 | 56.8 | 38.7 |
| Example 5B | 13.7 | 616 | 61.4 | 39.1 |
| Example 6B | 417.5 | 583 | 62.0 | 15.3 |
| Example 7B | 275.9 | 591 | 59.4 | 20.0 |
| Example 8B | 14.1 | 620 | 52.8 | 34.4 |
| Example 9B | 20.6 | 455 | 42.5 | 12.1 |
| Example 10B | 46.0 | 548 | 66.1 | 23.4 |
| Example 11B | 35.3 | 539 | 65.3 | 33.1 |
| Comparative | — | — | — | — |
| Example B | | | | |

In the case of Comparative Example B, polyimide particles with a uniform size were not prepared.

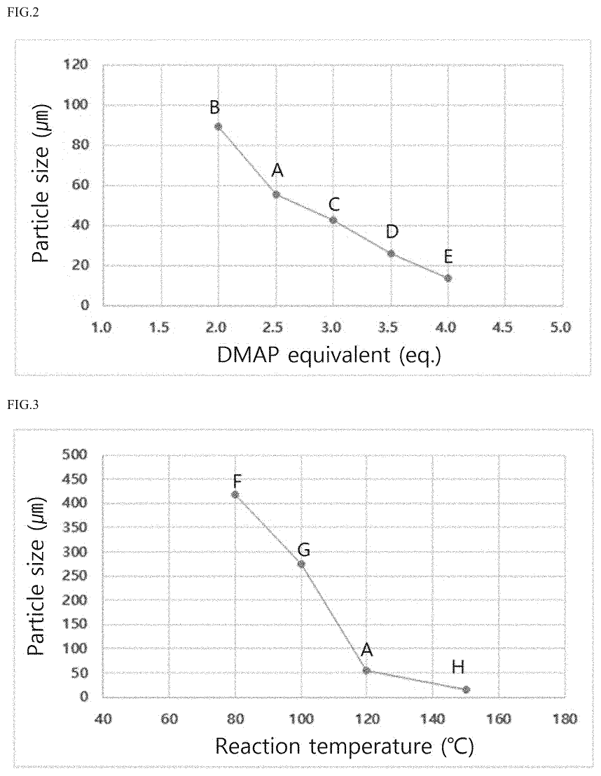

In addition, FIG. 2 is a graph showing a relationship between an aqueous catalyst content and a particle size, and FIG. 3 is a graph showing a relationship between a polymerization temperature and a particle size. Specifically, in FIGS. 2 and 3, A is a result of Example 1B, B is a result of Example 2B, C is a result of Example 3B, D is a result of Example 4B, E is a result of Example 5B, F is a result of Example 6B, G is a result of Example 7B, and H is a result of Example 8B.

From FIGS. 2 and 3, it can be confirmed that the particle size can be controlled by an aqueous catalyst content and a polymerization temperature.

1. A polyamic acid aqueous solution composition comprising:
a polyamic acid including a diamine monomer and a dianhydride monomer as polymerization units; and
a pyridine derivative compound having at least one electron donating group as an aqueous catalyst.

2. A polyamic acid aqueous solution composition comprising:
a polyamic acid including a diamine monomer and a dianhydride monomer as polymerization units; and
a pyridine derivative compound as an aqueous catalyst,
wherein an imidization rate ranges from 70 to 99.9% upon thermal curing at 200° C.

3. The polyamic acid aqueous solution composition of claim 1, wherein the aqueous catalyst satisfies the following Chemical Formula 1: 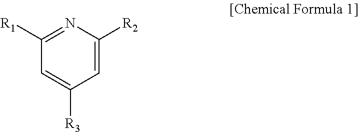
in Chemical Formula 1, at least one of R₁ to R₃ is an alkylamine group, a hydroxyl group, an alkoxy group, a thiol group, a thioether group, an alkyl group, or a heterocyclic group.

4. The polyamic acid aqueous solution composition of claim 1, wherein the aqueous catalyst satisfies the following Chemical Formula 2: 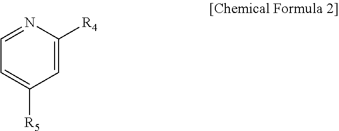
in Chemical Formula 2, at least one of R₄ and R₅ is a C1 to C4 monoalkylamino group, a C1 to C4 dialkylamino group, a hydroxyl group, a C1 to C4 alkoxy group, a thiol group, a C1 to C4 thioether group, a C1 to C4 alkyl group, a piperidino group, a morpholino group, or a pyrrolidino group.

5. The polyamic acid aqueous solution composition of claim 1, wherein the aqueous catalyst is included in a range of 0.5 to 5 equivalents with respect to 1 equivalent of the carboxyl group in the polyamic acid.

6. The polyamic acid aqueous solution composition of claim 1, wherein the dianhydride monomer includes at least one compound represented by the following Chemical Formula 3: 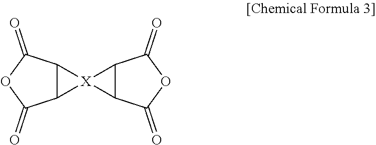
wherein X is a substituted or unsubstituted tetravalent aliphatic ring group, a substituted or unsubstituted tetravalent heteroaliphatic ring group, a substituted or unsubstituted tetravalent aromatic ring group, or a substituted or unsubstituted tetravalent heteroaromatic ring group, and
the aliphatic ring group, the heteroaliphatic ring group, the aromatic ring group, and the heteroaromatic ring group are present alone,
conjugated to each other to form a condensed ring, or
connected by a linking group including one or more divalent substituents selected from the group consisting of a single bond, a substituted or unsubstituted alkylene group, a substituted or unsubstituted alkylidene group, a substituted or unsubstituted alkenylene group, a substituted or unsubstituted alkynylene group, a substituted or unsubstituted arylene group, —O—, —S—, —C(═O)—, —S(═O)₂—, and —Si(Rₐ)₂— (where Rₐ is hydrogen or an alkyl group).

7. The polyamic acid aqueous solution composition of claim 1, wherein a solid content ranges from 1 to 30 wt %.

8. The polyamic acid aqueous solution composition of claim 1, wherein a cured product of the polyamic acid aqueous solution composition has a tensile strength of 50 to 400 MPa measured in accordance with ASTM D882 or a 5% thermal decomposition temperature (Td) of 400 to 700° C. measured using a thermogravimetric analyzer (TGA, Q5000 commercially available from TA Instruments, USA).

9. A method of preparing a polyamic acid, comprising preparing a polyamic acid using a pyridine derivative compound as an aqueous catalyst.

10. A method of preparing a polyimide, comprising:
preparing a polyamic acid using a pyridine derivative compound as an aqueous catalyst; and
thermally curing the polyamic acid at 250° C. or less to prepare a polyimide.

11. A method of preparing a polyimide powder, comprising:
polymerizing a diamine monomer and a dianhydride monomer in an aqueous solution including a pyridine derivative compound as an aqueous catalyst to prepare a polyamic acid; and
chemically imidizing the prepared polyamic acid to prepare a polyimide powder.

12. The method of claim 11, wherein the chemical imidization is performed by reacting the polyamic acid and a dehydrating agent.

13. The method of claim 12, wherein the dehydrating agent is included in a range of 0.5 to 3 equivalents with respect to 1 equivalent of the carboxyl group in the polyamic acid.

14. The method of claim 1, wherein the preparation of a polyimide powder includes:
refluxing a chemical imidization product of the polyamic acid at 100 to 150° C. for 1 to 5 hours; and
thermally imidizing and drying the refluxed product at less than 500° C.

15. The method of claim 9, the aqueous catalyst satisfies the following Chemical Formula 1: 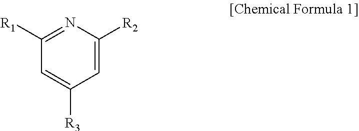
in Chemical Formula 1, at least one of R₁ to R₃ is an alkylamine group, a hydroxyl group, an alkoxy group, a thiol group, a thioether group, an alkyl group, or a heterocyclic group.

16. A method of manufacturing a polyimide molded article, comprising processing a polyimide powder prepared by the method of claim 11 to manufacture a polyimide molded article.

17. A polyimide powder prepared by the method of claim 11.

18. The polyimide powder of claim 17, wherein an average particle diameter ranges from 1 to 1000 μm, or a 5% thermal decomposition temperature (Td) measured using a thermogravimetric analyzer ranges from 400 to 700° C.

19. A polyimide molded article manufactured by the method of claim 16.

20. The polyimide molded article of claim 19, wherein a 5% thermal decomposition temperature (Td) measured using a thermogravimetric analyzer ranges from 400 to 700° C., or a coefficient of thermal expansion (CTE) measured by thermomechanical analysis ranges from 10 to 100 ppm/° C.
